(19) United States
(12) Patent Application Publication
(10) Pub. No.: US 2026/0046156 A1
(43) Pub. Date: Feb. 12, 2026

(54) METHOD AND APPARATUS FOR HEADER COMPRESSION FOR DATA FLOW VIA MULTIPLE ACCESS

(71) Applicant: SAMSUNG ELECTRONICS CO., LTD., Suwon-si (KR)

(72) Inventors: Dongeun SUH, Suwon-si (KR); Naman GUPTA, Suwon-si (KR); Jicheol LEE, Suwon-si (KR); Hoyeon LEE, Suwon-si (KR)

(21) Appl. No.: 19/292,773

(22) Filed: Aug. 6, 2025

(30) Foreign Application Priority Data
Aug. 7, 2024 (KR) 10-2024-0105364
Nov. 8, 2024 (KR) 10-2024-0158540

(51) Int. Cl. H04L 12/14; H04W 8/22; H04W 80/06

(52) U.S. Cl. CPC H04L 12/1407; H04W 8/22; H04W 80/06

(57) ABSTRACT

The disclosure relates to a 5G or 6G communication system for supporting higher data transmission rates. A method and apparatus for transmitting a message in a wireless communication system provide: receiving, from a UE, a first message including an indication of a request type and a PDU session type, wherein the request type is associated with a request for a MA PDU session; receiving, from a PCF, a second message including PCC rules, wherein the PCC rules include MA PDU session control information; setting the PDU session type as an IPv4, an IPv6, or an IPv4v6 when the PDU session type is set to Ethernet and a steering functionality parameter in the MA PDU session control information is set to a MPQUIC-E; and transmitting, to a RAN, a third message including the PDU session type.

### CROSS-REFERENCE TO RELATED APPLICATIONS

This application is based on and claims priority under 35 U.S. C. § 119 to Korean Patent Application Nos. 10-2024-0105364 and 10-2024-0158540, filed on Aug. 7, 2024 and Nov. 8, 2024, in the Korean Intellectual Property Office, the disclosure of which is herein incorporated by reference in its entirety.

### BACKGROUND

### 1. Field

The disclosure relates to a wireless communication system and, more specifically, to a header compression method and steering functionality selection for data flow via multiple access in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources. The above information is presented as background information only to assist with an understanding of the disclosure. No determination has been made, and no assertion is made, as to whether any of the above might be applicable as prior art with regard to the disclosure.

### SUMMARY

5G communication systems support connections with various access networks such as new radio (NR), wireless local area network (LAN), and wired LAN. Access traffic steering, switching, and splitting (ATSSS) technology, which enables traffic transmission using different access networks, is currently under development.

The disclosure, which addresses the above problem, provides a method performed by a session management function (SMF) in a wireless communication system, the method comprising: receiving, from a user equipment (UE), a first message including an indication of a request type and a packet data unit (PDU) session type, wherein the request type is associated with a request for a multi access packet data unit (MA PDU) session; receiving, from a policy control function (PCF), a second message including policy and charging control (PCC) rules, the PCC rules including MA PDU session control information; setting the PDU session type as IPv4, IPv6, or IPv4v6, in case that the PDU session type is ethernet and a steering functionality parameter in the MA PDU session control information is set to a multipath quick UDP internet connections-Ethernet (MPQUIC-E); and transmitting, to a radio access network (RAN), a third message including the PDU session type.

In an exemplary embodiment, wherein the first message further includes an access traffic steering, switching and splitting (ATSSS) capability, and wherein the ATSSS capability is associated with an MPQUIC-E functionality with any steering mode and an ATSSS Low-Layer (ATSSS-LL) functionality with only Active-Standby steering mode.

In an exemplary embodiment, further comprising: transmitting, to the PCF, a message including the indication associated with the request for the MA PDU session and the ATSSS capability of the MA PDU session.

In an exemplary embodiment, wherein the steering functionality parameter in the MA PDU session control information is determined based on the ATSSS capability of the MA PDU session by the PCF.

In accordance with another aspect of the disclosure, a method performed by a user equipment (UE) in a wireless communication system, the method comprising: transmitting, to a session management function (SMF), a first message including an indication of a request type and a packet data unit (PDU) session type, wherein the request type is associated with a request for a multi access packet data unit (MA PDU) session; and receiving, from a radio access network (RAN), a third message including the PDU session type, wherein the PDU session type is set as IPv4, IPv6, or IPv4v6, in case that the PDU session type is ethernet and a steering functionality parameter in MA PDU session control information is set to a multipath quick UDP internet connections-Ethernet (MPQUIC-E), wherein a second message including policy and charging control (PCC) rules is transmitted from a policy control function (PCF) to the SMF, the PCC rules including the MA PDU session control information.

In accordance with another aspect of the disclosure, a session management function (SMF), comprising: a transceiver configured to transmit or receive at least one signal; and at least one processor operatively coupled to the transceiver, wherein the at least one processor is configured to: receive, from a user equipment (UE), a first message including an indication of a request type and a packet data unit (PDU) session type, wherein the request type is associated with a request for a multi access packet data unit (MA PDU) session, receive, from a policy control function (PCF), a second message including policy and charging control (PCC) rules, the PCC rules including MA PDU session control information, set the PDU session type as IPv4, IPv6, or IPv4v6, in case that the PDU session type is ethernet and a steering functionality parameter in the MA PDU session control information is set to a multipath quick UDP internet connections-Ethernet (MPQUIC-E), and transmit, to a radio access network (RAN), a third message including the PDU session type.

In accordance with another aspect of the disclosure, a user equipment (UE), comprising: a transceiver configured to transmit or receive at least one signal; and at least one processor operatively coupled to the transceiver, wherein the at least one processor is configured to: transmit, to a session management function (SMF), a first message including an indication of a request type and a packet data unit (PDU) session type, wherein the request type is associated with a request for a multi access packet data unit (MA PDU) session, and receive, from a radio access network (RAN), a third message including the PDU session type, wherein the PDU session type is set as IPv4, IPv6, or IPv4v6, in case that the PDU session type is ethernet and a steering functionality parameter in MA PDU session control information is set to a multipath quick UDP internet connections-Ethernet (MPQUIC-E), wherein a second message including policy and charging control (PCC) rules is transmitted from a policy control function (PCF) to the SMF, the PCC rules including the MA PDU session control information.

According to an embodiment of the disclosure, a header compression method for data flow through multiple access may be performed more effectively, and a steering functionality may be selected.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an ATSSS support structure in a 3GPP 5G system according to an embodiment of the disclosure;

FIG. 2 illustrates an example of a PDU session establishment procedure according to an embodiment of the disclosure;

FIG. 3 illustrates an example of a structure of a UE according to an embodiment of the disclosure; and

FIG. 4 illustrates an example of a structure of a network entity according to an embodiment of the disclosure.

### DETAILED DESCRIPTION

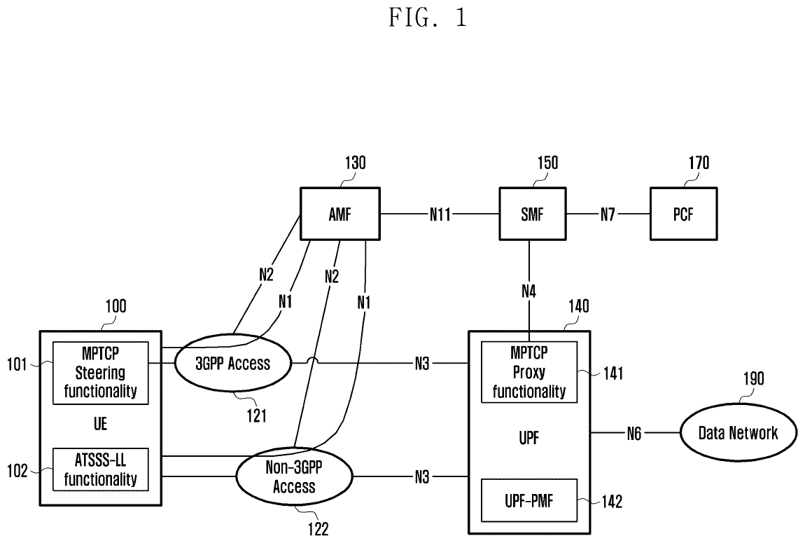

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail in conjunction with the accompanying drawings. In describing the disclosure, a detailed description of known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

FIG. 1 illustrates an example ATSSS support structure in a 3GPP 5G system according to an embodiment of the present disclosure. By utilizing the access traffic steering, switching, and splitting (ATSSS) function, it may be possible to transmit traffic via multiple paths between the PDU session anchor user plane function (UPF) (140) and a user equipment (UE) (100) as shown in FIG. 1. Meanwhile, to use ATSSS, a user equipment (UE) (100), an access and mobility management function (AMF)(130), a session management function (SMF)(150), or a user plane function (UPF) (140) may support the ATSSS function. ATSSS is provided via a multi-access PDU session. An MA PDU session may have both a user plane path to 3GPP access and a user plane path to non-3GPP access.

An MA PDU session may include one or more traffic flows (i.e., service data flow (SDF)). Each traffic flow may utilize both types of access based on a steering functionality (i.e., when transmitting application data via multiple access, the steering functionality is defined based on the type of application data transmitted and a protocol used via the multiple access) and a steering mode supported by each steering functionality (i.e., when transmitting data via multiple access, the steering mode is defined based on a method for inter-access traffic distribution—for example, active/standby, priority-based, etc.):
MPTCP steering functionality may be used to steer/switch/split transmission control protocol (TCP) traffic identified by ATSSS rules (rules configured in the UE to indicate a steering functionality/mode to be used for each type of uplink traffic) or N4 rules (rules configured in UPF to indicate a steering functionality/mode to be used for each type of downlink traffic).

The MPTCP steering functionality in the UE may transmit/receive application data to/from an MPTCP proxy located in the user plane function (UPF) (i.e., an MPTCP functionality in the UPF) (141) via 3GPP access and/or non-3GPP access by using an MPTCP protocol:
MPQUIC steering functionality may be used to steer/switch/split UDP traffic identified by the ATSSS rules/N4 rules.

The MPQUIC steering functionality in the UE may use an MPQUIC protocol (or a QUIC protocol) to transmit/receive application data to/from an MPQUIC proxy located in the user plane function (UPF) (i.e., MPQUIC functionality in the UPF) via 3GPP access and/or non-3GPP access. The MPQUIC protocol is an extension of the QUIC protocol that enables the QUIC protocol to be used in multiple paths:
ATSSS-LL steering functionality may be used to steer/switch/split all types of traffic (i.e., all PDU session types), including TCP traffic identified by ATSSS rules/N4 rules, UDP traffic, IP traffic, Ethernet traffic, unstructured traffic, etc.

The ATSSS-LL steering functionality in the UE may communicate with an ATSSS-LL proxy located in the user plane function (UPF) (i.e., an ATSSS-LL steering functionality in the UPF) via 3GPP access and/or non-3GPP access without any separate protocol (i.e., no separate protocol header is added). The ATSSS-LL steering functionality is responsible for transmitting traffic (i.e., PDU) to one of multiple types of access, depending on the context of the access, and receiving traffic from one or more types of access and delivering the received traffic to an application. ATSSS-LL does not support retransmission or re-ordering:
MPQUIC-Ethernet steering functionality may be used to steer/switch/split Ethernet traffic (i.e., all PDU session types) identified by ATSSS rules/N4 rules.

The MPQUIC-Ethernet steering functionality in the UE may transmit/receive application data to/from an MPQUIC-Ethernet proxy located in user plane function (UPF) (i.e., the MPQUIC-Ethernet steering functionality in the UPF) via 3GPP access and/or non-3GPP access by using an MPQUIC-Ethernet protocol. The MPQUIC-E steering functionality supports retransmission and re-ordering via the QUIC protocol.

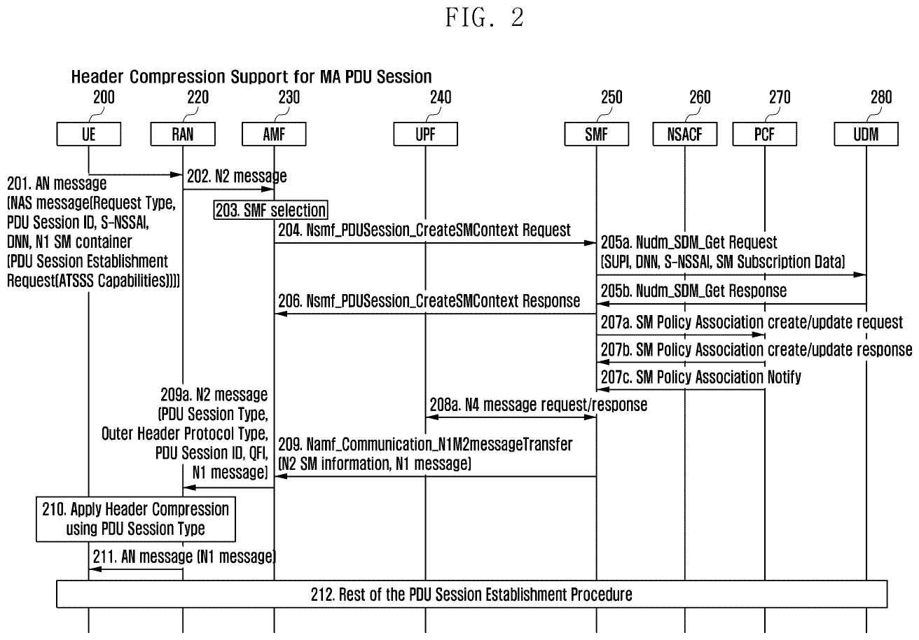

FIG. 2 illustrates an example of a PDU session establishment procedure according to an embodiment of the disclosure. For example, in FIG. 2, a RAN may be an NG-RAN. FIG. 2 may also be applied to a PDU session establishment procedure via a non-3GPP access. In this case, the RAN in FIG. 2 may be replaced with an access network (AN) and a non-3GPP interworking function (N3IWF).

Steps 201 to 202. When a UE (200) transmits a PDU session establishment request via 3GPP access (e.g., when a new PDU session or a MA PDU session for transmitting application data is required), the UE (200) may transmit a NAS message to an AMF (230).

The UE (200) may include the NAS message, which is to be transmitted the AMF (230), in an AN message, and transmit the AN message to the RAN (220). When the AN message including the NAS message is received, the RAN (220) may include the NAS message in an N2 message, and transmit the N2 message to the AMF (230). The NAS message may include the following information:
PDU session ID: PDU session identifier;
Request Type: Indicates the type of PDU session request, and may include an MA PDU request when the UE requests MA PDU session establishment. Otherwise, the request type may include an initial request, an existing PDU session, or an emergency request;
S-NSSAI: Network slice identifier (i.e., S-NSSAI) requested by the UE. If the UE is registered in both 3GPP access and non-3GPP access, only a network slice that are allowed in both types of access may be included;
DNN: Data network name (DNN) requested by the UE; and/or
N1 SM container: Includes the PDU session establishment request to be delivered to an SMF.

The PDU session establishment request may include the following information:
PDU Session ID: PDU session identifier.

Requested PDU Session Type: May indicate one of, for example, Ethernet, IP, or Unstructured. When application data to be transmitted is an Ethernet frame, the Requested PDU session type may indicate Ethernet:
5G SM Capability: Includes the session-related capability of the UE. If the UE supports an Ethernet PDU session, an indicator indicating support for an Ethernet PDU session type (i.e., a PDU session that supports a PDU including Ethernet frames) may be included. In addition, if the UE requests an MA PDU session, an ATSSS capability (the capability to utilize multiple access (e.g., 3GPP access and non-3GPP access) may be included.

The ATSSS capability may include a steering functionality supported by the UE (or intended to be used by the UE) (i.e., when transmitting application data via multiple access, the steering functionality is defined based on the type of application data transmitted and a protocol used via the multiple access) and a steering mode supported by each steering functionality (i.e., when transmitting data via multiple access, the steering mode is defined based on a method for inter-access traffic distribution—for example, active/standby, priority-based, etc.):
MPTCP steering functionality may be used to steer/switch/split TCP traffic identified by ATSSS rules (rules configured in the UE to indicate a steering functionality/mode to be used for each type of uplink traffic) or N4 rules (rules configured in a UPF to indicate steering functionality/mode to be used for each type of downlink traffic).

The MPTCP steering functionality in the UE may transmit/receive application data to/from an MPTCP proxy located in the user plane function (UPF) (i.e., an MPTCP functionality in the UPF) via 3GPP access and/or non-3GPP access by using an MPTCP protocol:
MPQUIC steering functionality may be used to steer/switch/split UDP traffic identified by the ATSSS rules/N4 rules.

The MPQUIC steering functionality in the UE may transmit/receive application data to/from an MPQUIC proxy located in the user plane function (UPF) (i.e., MPQUIC functionality in the UPF) via 3GPP access and/or non-3GPP access by using an MPQUIC protocol (or a QUIC protocol). The MPQUIC protocol is an extension of the QUIC protocol that enables the QUIC protocol to be used in multiple paths:
ATSSS-LL steering functionality may be used to steer/switch/split all types of traffic (i.e., all PDU session types), including TCP traffic identified by ATSSS rules/N4 rules, UDP traffic, IP traffic, Ethernet traffic, unstructured traffic, etc.

The ATSSS-LL steering functionality in the UE may communicate with an ATSSS-LL proxy located in the user plane function (UPF) (i.e., an ATSSS-LL steering functionality in the UPF) via 3GPP access and/or non-3GPP access without any separate protocol (i.e., no separate protocol header is added). The ATSSS-LL steering functionality is responsible for transmitting traffic (i.e., PDU) to one of multiple types of access, depending on the context of the access, and receiving traffic from one or more types of access and delivering the received traffic to an application. ATSSS-LL does not support retransmission or re-ordering:
MPQUIC-Ethernet steering functionality may be used to steer/switch/split Ethernet traffic (i.e., all PDU session types) identified by ATSSS rules/N4 rules.

The MPQUIC-Ethernet steering functionality in the UE may transmit/receive application data to/from the MPQUIC-Ethernet proxy located in the user plane function (UPF) (i.e., the MPQUIC-Ethernet steering functionality in the UPF) via 3GPP access and/or non-3GPP access by using an MPQUIC-Ethernet protocol. The MPQUIC-E steering functionality supports retransmission and re-ordering via the QUIC protocol.

The UE may include, in the ATSSS capability, information about one or more steering functionalities and a steering mode for each steering functionality.

Specifically, the ATSSS capability may include one or more of the following:
ATSSS-LL functionality with any steering mode;
MPTCP functionality with any steering mode and the ATSSS-LL functionality with only the active-standby steering mode;
MPTCP functionality with any steering mode and the ATSSS-LL functionality with any steering mode;
MPQUIC functionality with any steering mode and the ATSSS-LL functionality with any steering mode;
MPQUIC functionality with any steering mode and the ATSSS-LL functionality with only the active-standby steering mode;
MPQUIC-E functionality with any steering mode; and/or
MPQUIC-E functionality with any steering mode and ATSSS-LL functionality with any steering mode.

When the UE requests an MA PDU session and the PDU session type is Ethernet, the UE may include at least one of the ATSSS-LL steering functionality or the MPQUIC-E steering functionality in the ATSSS capability (i.e., the UE may be capable of supporting at least one thereof).

If the UE does not support both the ATSSS-LL steering functionality and the MPQUIC-E steering functionality, the UE may determine that it is not possible to transmit Ethernet traffic via an MA PDU session, and may transmit a PDU session establishment request message for establishing a normal PDU session (i.e., a PDU session with a user plane resource for one type of access).

If the UE supports both the ATSSS-LL steering functionality and the MPQUIC-E steering functionality, the UE may, based on UE implementation, determine to include only one, both, or neither of the steering functionalities.

If an application that triggered the MA PDU session establishment request does not support or requires re-ordering, the UE may include only the MPQUIC-E steering functionality in the ATSSS capability.

If an application that triggered the MA PDU session establishment request does not support re-ordering, requires re-ordering, or requires a steering mode other than active standby (e.g., smallest delay, load balancing or redundant), the UE may preferentially select MPQUIC-E for the corresponding SDF.

If an application that triggered the MA PDU session establishment request is one of the aforementioned applications and if the UE does not support the MPQUIC-E steering functionality, the UE may determine that it is not possible to transmit Ethernet traffic via an MA PDU session, and may not transmit the MA PDU session establishment request message. In this case, the UE may transmit a PDU session establishment request message for establishing a normal PDU session (i.e., a PDU session with a user plane resource for one type of access).

Step 203. If the request type in the NAS message included in the N2 message transmitted in step 202 is an MA PDU request, the AMF (230) may select an SMF that supports an MA PDU session.

Step 204. The AMF (230) may transmit an Nsmf_PDUSession_CreateSMContext request (S-NSSAI, DNN, PDU session ID, MA PDU indication, or N1 SM container (PDU session establishment request)) to the SMF (250). The AMF (230) may include information included in the NAS message received from the UE (200) in a message that is transmitted to the SMF (250). If the PDU request type, included in the NAS message received from the UE (200), is an MA PDU request, the AMF (230) may include an MA PDU request indication in the message which is transmitted to the SMF (250).

Step 205a. The SMF (250) may request SM subscription data of the UE by transmitting an Nudm_SDM_Get request (SUPI, DNN, S-NSSAI, or SM subscription data) to a unified data management (UDM).

Step 205b. The UDM (280) may use an Nudm_SDM_Get response message to transmit, to the SMF (250), subscription information requested in the message received from the SMF (250). The subscription information may include information on whether the MA PDU session is allowed.

Step 206. The Smf (250) may Transmit an Nsmf_PDUSession_CreateSMContext response message to the AMF (230). A result indicating failure may be included in the message if the information received in step 205b indicates that the MA PDU session is not allowed, or if the information received in step 205b does not include information that allows the MA PDU session.

Step 207a. The SMF (250) may transmit an SM policy association creation (or update) request to a policy control function (PCF) (270). A message for the SM policy association creation (or update) request may include the following information:
SUPI, DNN, S-NSSAI, PDU session ID, or PDU session type;
IP address: If the PDU session type is IPv4, IPv6, or IPv4v6, an IP address (e.g., IPv4 or IPv6 address/prefix) assigned by the SMF may be included; and/or
MA PDU Request and ATSSS Capabilities: If dynamic policy and charging control (PCC) is configured to be used for an MA PDU session, and/or if the message received in step 204 includes the MA PDU indication, the SMF (250) may include an MA PDU request and ATSSS capabilities (received from the UE) in the message.

If the received message includes an MA PDU request, the PCF may determine whether to allow the MA PDU session, based on subscription information and/or operator policy information.

If the PCF (270) allows an MA PDU session, the PCF may generate a PCC rule that includes MA PDU session control information, QoS information, and a service description flow (SDF) template (which may include a 5-IP tuple or application ID) that enables the detection of the traffic for each traffic flow that may use the session. The QoS information may include 5G QoS identifier (5QI), ARP, UL maximum data rate, DL maximum data rate, UL/DL guaranteed data rate, etc. Furthermore, the MA PDU session control information may include a traffic descriptor (i.e., an application descriptor).

The PCF (270) may include an application descriptor in the MA PDU session control information according to an operator's policy. The application descriptor may be included when a PCC-level SDF includes only an application ID, or when it is desired to apply a steering functionality and a steering mode to a traffic flow that is more granular than a PCC rule-level SDF.

The MA PDU session control information includes information indicating which steering functionality and steering mode are to be used by the corresponding SDF (or application descriptor), separately for uplink and downlink.

The PCF (270) may determine MA PDU session control information for each SDF, based on an ATSSS capability and a steering functionality supported by the network. If one or more steering functionalities are available (e.g., when the PDU session type is Ethernet PDU type, and MPQUIC-E and ATSSS-LL are both supported by the UE and the network), the PCF may make the determination, based on an operator policy or subscriber information. For example, for SDFs representing an application traffic flow that is under a contract with an operator, MPQUIC-E may be preferentially selected based on the contract. For example, MPQUIC-E may be preferentially selected for an SDF representing a specific application traffic flow that does not support (or requires) re-ordering. For example, in the case of a specific application that requires smallest delay, load balancing, or redundant during steering mode, MPQUIC-E may be preferentially selected for a corresponding SDF.

The PCF (270) may include an application descriptor in the MA PDU session control information according to the operator policy. The application descriptor may be included when a PCC-level SDF includes only an application ID, or when a steering functionality and a steering mode are to be applied to a traffic flow that is more granular than a PCC rule-level SDF.

For an SDF in which a separate lower protocol for PDU transmission exists (e.g., for an SDF in which a steering functionality is MPQUIC-E steering functionality) or for an SDF in which a separate lower protocol over which a PDU is transmitted exists and a PDU session type is different (e.g., for an SDF in which the steering functionality is an MPQUIC-E steering functionality and the PDU session type is Ethernet), the PCF (270) may include, in the PCC rule or PDU session policy information, a protocol type to be applied to compression (which may be referred to as protocol type for header compression, or outer header protocol type). Alternatively, the PDU session policy information may include, instead of a protocol type, a steering functionality (e.g., ATSSS-LL or MPQUIC-E) to be applied to a PDU session.

The PCF (270) may include a protocol type corresponding to a protocol type for header compression (or an outer header protocol type) according to a lower protocol type according to the steering functionality. For example, in the case of MPQUIC-E, MPQUIC-IP, or MPQUIC steering functionality, IPv4 or Ipv6 may be included. If the protocol type is included in the PDU session policy information, the protocol type may mean a protocol type for header compression (or outer header protocol type) for a PDU session.

In another embodiment, for SDFs in which there is a separate lower protocol over which the PDU is transmitted and the a PDU session type is different (e.g., an SDF in which the steering functionality is an MPQUIC-E steering functionality and the PDU session type is Ethernet), the PCF (270) may determine to include an indicator for not to apply header compression to a PDU session in the PDU session policy information that is transmitted to the SMF (250).

Step 207b. The PCF (270) may transmit the PCC rule(s) and the PDU session policy information to the SMF (250). The PCC rule(s) may be transmitted as a response message to step 207a or as a separate notification message (step 207c).

Based on the PCC rule, the SMF (250) may generate rules indicating which steering functionality and steering mode are to be applied to each traffic flow. In this case, a rule to be applied to uplink traffic (i.e., a rule to be transmitted to the UE) is called an ATSSS rule, and a rule to be applied to downlink traffic is called an N4 rule.

Step 208a. The SMF (250) may select a user plane function (UPF) that supports MA PDU session/ATSSS, and transmit a message for configuring the N4 rule. The UPF (280) may transmit a response message to the N4 message.

Step 209. The SMF (250) may transmit, to the AMF (230), a message requesting the delivery of an N1 SM container, transmitted to the UE (200), and N2 SM information, transmitted to a base station (220).

The N2 SM information may include the following information:
PDU session ID, CN tunnel Info, S-NSSAI from the allowed NSSAI or partially allowed NSSAI, session-AMBR; and/or
PDU session type.

If the PDU session type of a PDU session is Ethernet (e.g., when the PDU session type received in step 204 is Ethernet), the SMF may include a PDU session type indicating Ethernet.

If the SMF (250) receives the indicator for not to apply header compression from the PCF (270), the SMF (250)may not include the PDU session type in a message transmitted to the RAN, may configure the PDU session type in the message transmitted to be the RAN (220) to be “unstructured,” or may configure the PDU session type to be a protocol type different from the outer header protocol type (e.g., Ethernet may be included in the case of a PDU session in which an MPQUIC-E or MPQUIC-IP steering functionality can be applied). If the SMF (250) receives an outer header protocol type (or protocol type for header compression) from the PCF (270), it may, based on the corresponding information, configure a PDU session type, included in the N2 SM information transmitted to the RAN (220), in the message transmitted to the RAN (220).

Alternatively, when the PDU session policy information received from the PCF (270) includes a steering functionality to be applied to the PDU session instead of the protocol type, the SMF (250) may, based on the corresponding information, configure a PDU session type, included in the N2 SM information transmitted to the RAN (220), in the message transmitted to the RAN (220). For example, when the steering functionality included in the PDU session policy information received from the PCF is ATSSS-LL and the PDU session type is Ethernet, the SMF (250) may determine that the PDU session type is Ethernet. For example, when the steering functionality included in the PDU session policy information received from the PCF (270) is MPQUIC-E, the SMF (250) may determine the PDU session type to be one of IPv4, IPv6, or IPv4v6 based on configuration information according to the steering functionality.

When a PDU session is an MA PDU session (e.g., the SMF receives an MA PDU request in step 204), and the PDU session type of the PDU session is Ethernet (e.g., the PDU session type received in step 204 is Ethernet) or IP (i.e., Ipv4, Ipv6, or IPv4v6), the SMF (250) may operate according to the following conditions:
If MPQUIC-E is used as a steering functionality for all traffic flows for a PDU session (e.g., if the MA PDU session supports only MPQUIC-E), the SMF (250) may include, in the N2 SM information, a PDU session type configured as an outer header protocol type (e.g., Ipv4 or Ipv6 or Ipv4v6) used by MPQUIC-E. The outer header protocol type may be determined based on information received from the PCF (270);
If MPQUIC-IP is used as a steering functionality for all traffic flows for a PDU session (e.g., if the MA PDU session support only MPQUIC-IP), the SMF (250) may include, in the N2 SM information, a PDU session type configured as an outer header protocol type (e.g., Ipv4 or Ipv6 or Ipv4v6) used by MPQUIC-IP. The outer header protocol type may be determined based on information received from the PCF (270);
Alternatively, if MPQUIC-E is used as a steering functionality for all traffic flows for a PDU session (e.g., if the MA PDU session supports only MPQUIC-E), the SMF (250) may not include the PDU session type in the N2 SM information. This allows the RAN (220) to avoid performing header compression;
If ATSSS-LL is used as a steering functionality for all traffic flows for a PDU session (e.g., if the MA PDU session supports only ATSSS-LL), the SMF (250) may include a PDU session type configured as Ethernet in the N2 SM information;
If a PDU session is capable of supporting both MPQUIC-E and ATSSS-LL, the SMF (250) may not include a PDU session type in the N2 SM information, or may include a PDU session type configured to be “unstructured” or Ethernet in the N2 SM information. This may allow the RAN (220) to avoid performing header compression; and/or
Outer header protocol type per SDF (or per QoS flow).

The SMF (250) may include an outer header protocol type in the N2 SM information if a PDU session is an MA PDU session (e.g., receiving an MA PDU request in step 204) and the PDU session type of the PDU session is Ethernet (e.g., the PDU session type received in step 204 is Ethernet). For example, if MPQUIC-E is used as a steering functionality for all traffic flows for a PDU session (e.g., if the MA PDU session supports MPQUIC-E), the SMF (250) may include an IP protocol (IPv4, iPv6) used by MPQUIC-E in the outer header protocol type.

In another embodiment, if a PDU session is an MA PDU session and the PDU session type of the PDU session is Ethernet, the SMF (250) may configure a PDU session type included in the N2 SM information as Ethernet, and include a traffic flow-specific (e.g., QoS flow-specific, or SDF-specific) outer header protocol type in the N2 SM information. For example, if an ATSSS-LL steering functionality is used in a traffic flow (QoS flow or SDF), an outer header protocol type for the traffic flow may be configured as Ethernet, which is the same as the PDU session type. For example, if an MPQUIC-E steering functionality is used for a traffic flow (QoS flow or SDF), an IP protocol (IPv4 or iPv6) used by MPQUIC-E may be included in the outer header protocol type:
Qfi(s) and Qos Profile(s).

QFI and QoS Profile per QoS flow may be included:
N1 SM Container.

The N1 SM container may include a PDU session establishment accept message. The PDU session establishment accept message may include the following information:
QoS Rule(s) and associated UL Protocol Description(s) (if available), QoS Flow level QoS parameters if needed for the QoS Flow(s) associated with the QoS rule(s), selected SSC mode, S-NSSAI(s), UE Requested DNN, allocated IPv4 address; and/or
Selected PDU session type.

Step 209a. The AMF (230) includes the information included in the N2 SM information and an N1 message, received in step 209, in an N2 message transmitted to the NG-RAN (220). In this case, the PDU session type determined in step 209 and the outer header protocol type, if present, may be included.

Step 210. When a PDU session type is included in an N2 SM message, the NG-RAN (220) may perform header compression for the user plane traffic, based on the PDU session type.

If a PDU session type and an outer header protocol type are included together, header compression may be performed based on the outer header protocol type.

If a traffic flow-specific outer header protocol type is included, the RAN may perform header compression based on the outer header protocol type for the traffic flow. For example, if an outer header protocol type is IPv4 (or Ipv6), robust header compression (ROHC) may be applied between the UE and the RAN.

For example, if an outer header protocol type is Ethernet, Ethernet header compression (EHC) may be applied between the UE and the RAN.

If a PDU session type is not included in the N2 SM message, the RAN (220) does not perform header compression for the PDU session. Alternatively, the RAN (220) may store, as configuration information, information about whether to apply or not apply header compression per S-NSSAI and/or DNN. Even when a PDU session type is included in the N2 SM message, the RAN (220) configured in this way may not perform header compression for the PDU session if the S-NSSAI and/or DNN received in step 209a indicates, in the configuration information, that header compression may not be applied.

Alternatively, the RAN (220) may store, as configuration information, information about whether or not to apply header compression to each QFI. Even when a PDU session type is included in the N2 SM message, the RAN (220) configured in this way may not perform header compression for the corresponding QoS flow if the QFI received in step 209a indicates that header compression may not be applied.

Step 211. The NG-RAN (220) may transmit the N1 message included in the received N2 SM message to the UE (200).

Step 212. The rest of the PDU session establishment procedure may proceed.

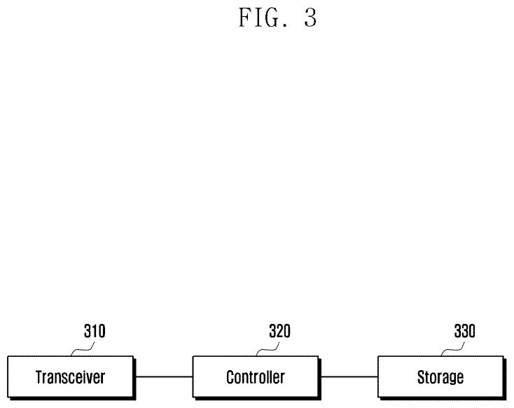

FIG. 3 illustrates an example of a structure of a UE according to an embodiment of the disclosure.

Referring to FIG. 3, the UE may include a transceiver 310, a controller 320, and a storage 330. In the disclosure, the controller may be defined as a circuit or an application-specific integrated circuit or at least one processor.

The transceiver 310 may transmit/receive signals with other network entities.

The controller 320 may control the overall operation of the UE according to the embodiments provided in the disclosure. For example, the controller 320 may control signal flows between the respective blocks to perform operations according to the above-described flowcharts.

In addition, the storage 330 may store at least one of information transmitted/received through the transceiver 310 and information generated through the controller 320.

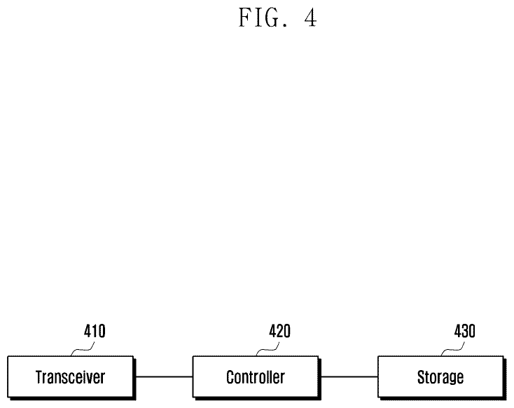

FIG. 4 illustrates an example of a structure of a network entity according to an embodiment of the disclosure.

Referring to FIG. 4, the network entity may include a transceiver 410, a controller 420, and a storage 430. In the disclosure, the controller may be defined as a circuit or an application-specific integrated circuit or at least one processor.

The transceiver 410 may transmit/receive signals with other network entities.

The controller 420 may control the overall operation of the network entity according to the embodiments provided in the disclosure. For example, the controller 420 may control signal flows between the respective blocks to perform operations according to the above-described flowcharts. In addition, the storage 430 may store at least one of information transmitted/received through the transceiver 410 and information generated through the controller 420.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a session management function (SMF) in a wireless communication system, the method comprising:
receiving, from a user equipment (UE), a first message including an indication of a request type, and a packet data unit (PDU) session type, wherein the request type is associated with a request for a multi access packet data unit (MA PDU) session;
receiving, from a policy control function (PCF), a second message including policy and charging control (PCC) rules, wherein the PCC rules include MA PDU session control information;
setting the PDU session type as an internet protocol version 4 (IPv4), an IPv6, or an IPv4v6 in case that the PDU session type is ethernet and a steering functionality parameter in the MA PDU session control information is set to a multipath quick user datagram protocol (UDP) internet connections-Ethernet (MPQUIC-E); and
transmitting, to a radio access network (RAN), a third message including the PDU session type.

2. The method of claim 1, wherein the first message further includes an access traffic steering, switching and splitting (ATSSS) capability, and
wherein the ATSSS capability is associated with an MPQUIC-E functionality with any steering mode and an ATSSS Low-Layer (ATSSS-LL) functionality with only Active-Standby steering mode.

3. The method of claim 2, further comprising:
transmitting, to the PCF, a message including the indication associated with the request for the MA PDU session and the ATSSS capability of the MA PDU session.

4. The method of claim 2, wherein the steering functionality parameter in the MA PDU session control information is determined based on the ATSSS capability of the MA PDU session by the PCF.

5. A method performed by a user equipment (UE) in a wireless communication system, the method comprising:
transmitting, to a session management function (SMF), a first message including an indication of a request type, and a packet data unit (PDU) session type, wherein the request type is associated with a request for a multi access packet data unit (MA PDU) session; and
receiving, from a radio access network (RAN), a third message including the PDU session type, wherein the PDU session type is set as IPv4), an IPv6, or an IPv4v6, in case that the PDU session type is ethernet and a steering functionality parameter in MA PDU session control information is set to a multipath quick user datagram protocol (UDP) internet connections-Ethernet (MPQUIC-E),
wherein a second message including policy and charging control (PCC) rules is transmitted from a policy control function (PCF) to the SMF, the PCC rules including the MA PDU session control information.

6. The method of claim 5, wherein the first message further includes an access traffic steering, switching and splitting (ATSSS) capability, and
wherein the ATSSS capability is associated with an MPQUIC-E functionality with any steering mode and an ATSSS Low-Layer (ATSSS-LL) functionality with only Active-Standby steering mode.

7. The method of claim 6, wherein a message is transmitted from the SMF to the PCF, the message including the indication associated with the request for the MA PDU session and the ATSSS capability of the MA PDU session.

8. The method of claim 6, wherein the steering functionality parameter in the MA PDU session control information is determined based on the ATSSS capability of the MA PDU session by the PCF.

9. A session management function (SMF), comprising:
a transceiver configured to transmit or receive at least one signal; and
at least one processor operatively coupled to the transceiver, the at least one processor configured to:
receive, from a user equipment (UE), a first message including an indication of a request type, and a packet data unit (PDU) session type, wherein the request type is associated with a request for a multi access packet data unit (MA PDU) session,
receive, from a policy control function (PCF), a second message including policy and charging control (PCC) rules, wherein the PCC rules include MA PDU session control information,
set the PDU session type as an internet protocol version 4 (IPv4), an IPv6, or an IPv4v6, in case that the PDU session type is ethernet and a steering functionality parameter in the MA PDU session control information is set to a multipath quick user datagram protocol (UDP) internet connections-Ethernet (MPQUIC-E), and
transmit, to a radio access network (RAN), a third message including the PDU session type.

10. The SMF of claim 9, wherein the first message further includes an access traffic steering, switching and splitting (ATSSS) capability, and
wherein the ATSSS capability is associated with an MPQUIC-E functionality with any steering mode and an ATSSS Low-Layer (ATSSS-LL) functionality with only Active-Standby steering mode.

11. The SMF of claim 10, wherein the at least one processor is further configured to transmit, to the PCF, a message including the indication associated with the request for the MA PDU session and the ATSSS capability of the MA PDU session.

12. The SMF of claim 10, wherein the steering functionality parameter in the MA PDU session control information is determined based on the ATSSS capability of the MA PDU session by the PCF.

13. A user equipment (UE), comprising:
a transceiver configured to transmit or receive at least one signal; and
at least one processor operatively coupled to the transceiver, wherein the at least one processor is configured to:
transmit, to a session management function (SMF), a first message including an indication of a request type, and a packet data unit (PDU) session type, wherein the request type is associated with a request for a multi access packet data unit (MA PDU) session, and
receive, from a radio access network (RAN), a third message including the PDU session type, wherein the PDU session type is set as IPv4, an IPv6, or an IPv4v6, in case that the PDU session type is ethernet and a steering functionality parameter in MA PDU session control information is set to a multipath quick user datagram protocol (UDP) internet connections-Ethernet (MPQUIC-E),
wherein a second message including policy and charging control (PCC) rules is transmitted from a policy control function (PCF) to the SMF, the PCC rules including the MA PDU session control information.

14. The UE of claim 13, wherein the first message further includes an access traffic steering, switching and splitting (ATSSS) capability, and
wherein the ATSSS capability is associated with an MPQUIC-E functionality with any steering mode and an ATSSS Low-Layer (ATSSS-LL) functionality with only Active-Standby steering mode.

15. The UE of claim 14, wherein a message is transmitted from the SMF to the PCF, the message including the indication associated with the request for the MA PDU session and the ATSSS capability of the MA PDU session.

16. The UE of claim 14, wherein the steering functionality parameter in the MA PDU session control information is determined based on the ATSSS capability of the MA PDU session by the PCF.
